(19) United States
(12) Patent Application Publication
(10) Pub. No.: US 2013/0007724 A1
(43) Pub. Date: Jan. 3, 2013

(54) FIRMWARE REPAIRABLE CUSTOMER PREMISES EQUIPMENT AND FIRMWARE REPAIRING METHOD THEREOF

(75) Inventors: Yan-Cheng LAI, Taichung City (TW); Yi-Chun LO, Taichung City (TW)

(73) Assignees: UNIVERSAL GLOBAL SCIENTIFIC INDUSTRIAL CO., LTD., Nantou County (TW); UNIVERSAL SCIENTIFIC INDUSTRIAL (SHANGHAI) CO., LTD., Shanghai (CN)

(21) Appl. No.: 13/361,695

(22) Filed: Jan. 30, 2012

(30) Foreign Application Priority Data
Jun. 29, 2011 (TW) 100122827

(51) Int. Cl. G06F 9/44

(52) U.S. Cl. 717/173

(57) ABSTRACT

A firmware repairing method for customer premises equipment (CPE) is illustrated. The method includes reading and detecting whether a first firmware is damaged, reading and loading a second firmware so as to activate network services when the first firmware damaged, and enabling communication between the CPE and an external device via a network. The CPE may be controlled by the external device for executing a repairing grogram and may receive an updated firmware from the external device for replacing the damaged first firmware.

### BACKGROUND OF THE INVENTION

1. Field of the Invention

The present invention relates to a Customer Premises Equipment (CPE) and repairing method thereof, and, more particularly, to a CPE that is capable of repairing firmware therein and a firmware repairing method thereof

2. Description of Related Art

Traditionally, the CPE is placed at the location beyond people's reach. Additionally, the outdoor CPE is often located in an area without reliable power supply, which in turn may cause the firmware in the CPE not to properly function in the event of power outage during firmware updating. Consequently, an operating system of the CPE could not take over when the firmware of the CPE is damaged and fails to be loaded into memory of the CPE for booting purpose of the CPE. Currently-existing approaches for repairing of the damaged firmware in the CPE require maintenance people to perform repairing tasks in proximity of the CPE, causing inconvenience and inefficiency.

### SUMMARY OF THE INVENTION

An exemplary embodiment of the present disclosure provides a firmware repairing method of the CPE. The CPE includes a storage unit, a processing unit, and a network interface unit. The firmware repairing method includes reading a first firmware stored in the storage unit and determining whether the first firmware is damaged, reading a second firmware stored in the storage unit when the first firmware is damaged, and loading the second firmware into a memory unit for execution. The firmware repairing method further includes activating network services based on instructions of the second firmware and enabling communication between the CPE and an external device via a network. The CPE may also be controlled by the external device or receive control-related commands from the external device for executing a repairing program and receive an updated firmware from the external device for replacing the damaged first firmware according to the repairing program.

Furthermore, an exemplary embodiment of the present disclosure provides a CPE capable of repairing the firmware therein that includes a storage unit storing a first firmware and a second firmware, a processing unit, and a network interface unit. The network interface unit is utilized for connecting with an external device. When the CPE boots, the processing unit is utilized for determining whether or not the first firmware is damaged. If the first firmware is damaged, the processing unit loads the second firmware into a memory unit for executing the second firmware. When the second firmware is executed, the processing unit performs instructions of the second firmware for activating network services, enabling the communication between the external device and the CPE via the network interface unit, and receiving the updated firmware from the external device to replace the damaged firmware.

Next, an exemplary embodiment of the present disclosure provides a computer readable storage medium utilized for recording therein a set of computer programs including a first firmware, a second firmware, a verification program, and a switch program, for carrying out a firmware repairing method including steps in the above-mentioned firmware repairing method.

To sum up, the exemplary embodiment of the present disclosure provides the CPE and the firmware repairing method thereof for automatically determining whether the first firmware is damaged, automatically switching and executing the second firmware when the first firmware is damaged, and executing the second firmware allowing for the CPE to boot normally while repairing the damaged first firmware.

In order to further the understanding regarding the present invention, the following embodiments are provided along with illustrations to facilitate the disclosure of the present invention.

### BRIEF DESCRIPTION OF THE DRAWINGS

FIG. 1 shows a flow chart of a firmware repairing method of a CPE according to an exemplary embodiment of the present disclosure;

FIG. 2 shows a flow chart indicative of a procedure of communication between a CPE and an external device according to an exemplary embodiment of the present disclosure;

FIG. 3 shows a block diagram of a CPE capable of repairing firmware therein according to an exemplary embodiment of the present disclosure; and

FIG. 4 shows a block diagram of a CPE capable of repairing firmware therein according to an exemplary embodiment of the present disclosure.

### DETAILED DESCRIPTION OF THE PREFERRED EMBODIMENTS

The aforementioned illustrations and following detailed descriptions are exemplary for the purpose of further explaining the scope of the present invention. Detailed embodiments will be illustrated in the subsequent descriptions and appended drawings.

[Exemplary Embodiment of a Firmware Repairing Method of a CPE]

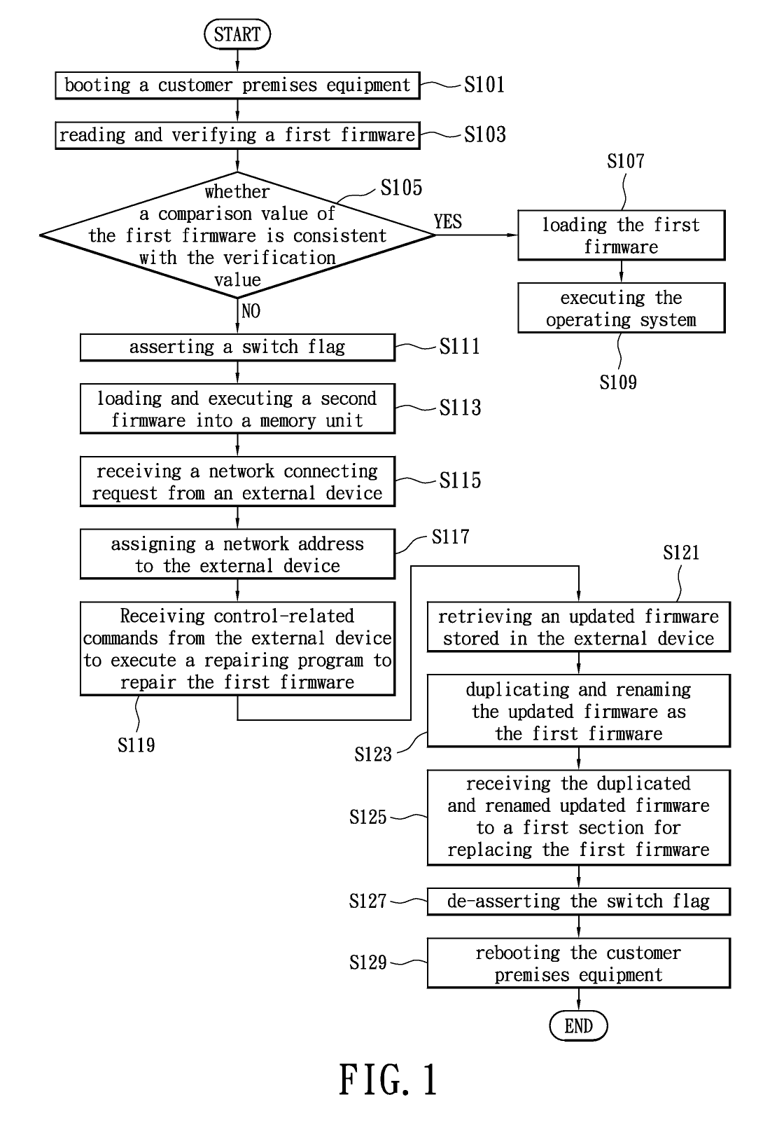

Please refer to FIG. 1, which illustrates a flow chart of a firmware repairing method of a CPE according to an exemplary embodiment of the present disclosure. The CPE of the exemplary embodiment may be an outdoor hardware device utilized for accessing network services, such as a WiMAX (Worldwide Interoperability for Microwave Access) base station and the like.

Since the CPE 1 is often placed higher than people reachable altitudes such as at the top of a streetlamp, and also accompanies unstable power supply in some areas. Under those situations, the firmware is easily damaged due to power outage or broken during firmware upgrading or updating, both of which result in the CPE 1 cannot boot normally. Therefore, the repairing method in the present embodiment may be used for determining whether the firmware of the CPE 1 is damaged such as failure of data integrity, and control the CPE 1 to switch to other firmware for the firmware execution purpose once the firmware of the CPE 1 is determined damaged. In doing so, the repairing method of the present invention could ensure the CPE 1 to operate properly and may repair the damaged firmware at the same time.

Please refer to FIG. 1. In the exemplary embodiment, when the CPE 1 is turned on (S101), a processing unit of the CPE 1 may read an image file of a first firmware stored in a storage unit according to instructions of a boot loader, and the processing unit may execute a verification program for determining whether the first firmware is damaged (S103), such as determining the data integrity of the first firmware is damaged or not.

The verification program may be configured to open the first firmware image file and read a predetermined verification value stored at the end of the image file in terms of data structure. The verification program may also be configured to calculate the data of the first firmware for generating a comparison value associated with the first firmware via the same algorithm used for generating the verification value. Thereafter, the verification value and the comparison value may be compared for determining whether both the verification value and the comparison value are consistent or not, so as to determine the first firmware is damaged or not (S105). The verification value may be a string of numerals or a single-digit numeric value recorded in the end of the data structure of the first firmware. In one implementation, the verification value may be calculated via a specific algorithm in advance, such as a hash value with a fixed length based on Message-Digest 5 (MD5) algorithm. The algorithms used for generating the verification value corresponding to the first firmware could further include other algorithms such as SHA-1 or SHA-256, and so on.

When the verification value is consistent with the comparison value, the integrity of the first firmware is confirmed, and the first firmware may be determined not damaged. The processing unit may then decompress the image file of the first firmware and load the decompressed file into a memory unit, such as main memory, for the execution purpose (S107). Therefore, the CPE 1 may start to initialize hardware components of the CPE 1 and load an operating system into the memory unit (S109).

On the other hand, when the comparison value and the verification value are inconsistent, which indicates the integrity of the first firmware may not be maintained and the content of the first firmware may be damaged. For example, the integrity of the image file is not maintained due to the power outage during upgrading or updating of the image file of the first firmware. The processing unit may then execute a switch program to flag the first firmware as “damaged” accordingly, such as asserting a switch flag in an assigned address of the memory unit (S111).

Next, the processing unit may be configured to load a second firmware stored in the storage unit into the memory unit based on the asserted switch flag (S113). In the exemplary embodiment, according to the command of the switch program, the file name of image file of the first firmware may be renamed after another file name (e.g., the file name other than the file name of the first firmware as well as the file name of the second firmware) and also the file name of image file of the second firmware may be renamed after the original file name of the image file of the first firmware before the processing unit loads the second firmware into the memory unit. Accordingly, replacing or repairing the damaged firmware may be more efficient and more convenient as the processing unit may thereafter simply select and load the image file into the memory unit based on the updated file name without knowing whether the content of the selected firmware has changed.

It is noteworthy that the above-described approaches for indicating the first firmware may be damaged and facilitating the loading of the second firmware are just exemplary embodiments, and the present disclosure is not limited thereto. For example, when the first firmware is determined damaged, the processing unit may directly retrieve an address where the second firmware is stored, and load the second firmware into the memory unit by reading the second firmware from designated address.

When the second firmware has been loaded into the memory unit, the CPE may base on the data of second firmware to execute an address assigning program, a remote control program, and a file transferring program to activate multiple network services. The multiple network services may include: (1) executing a dynamic host configuration protocol (DHCP) and configure the CPE as a dynamic host configuration protocol server (DHCP server) for providing a network address assigning service, (2) executing a Telnet protocol and configure the CPE as a Telnet server at the same time for providing a remote login service so that the external device could log onto the CPE remotely, and (3) executing a File Transfer Protocol (FTP) and configure the CPE as FTP client for enabling file downloading from other FTP servers.

When the above-mentioned services are activated, the CPE may receive a network connecting request from the external device (S115). The external device may physically connect with a network interface unit of the CPE by a network cable. When the physical link is established, both the CPE and the external device are at the same sub-network, and therefore, the external device may search the DHCP server in the sub-network for a network address assigned by the CPE (i.e. the DHCP server) (S117), completing the network connection between the CPE and the external device.

After the network connection is set up, according to the activated remote login service, the CPE may further allow for the external device to log onto the CPE now and serve as the Telnet server. The processing unit may therefore receive a repairing command, which is a part of control-related commands from the external device, sent from the external device for executing a repairing program to repair the first firmware (S119).

The repairing program may be written in terms of a predetermined script language. The processing unit, according to the repairing program and the activated file transfer service, communicates with the external device serving as a FTP server and storing an image file of an updated firmware (S121). Thereafter, the CPE may follow the instruction of the repairing program to duplicate the image file of the updated firmware and transmit the duplicated image file back to the CPE, and may rename the updated firmware after the original file name of the damaged first firmware (S123). The duplicated and renamed updated firmware may be saved in the storage section where the damaged first firmware was saved, accomplishing the replacement of the damaged first firmware (S125). The executed repairing program may further instruct the processing unit to de-assert the switch flag (S127) and reboot the CPE (S129). Therefore, when the CPE reboots the updated/replaced first firmware instead of the second firmware asserted by the switch flag may be loaded.

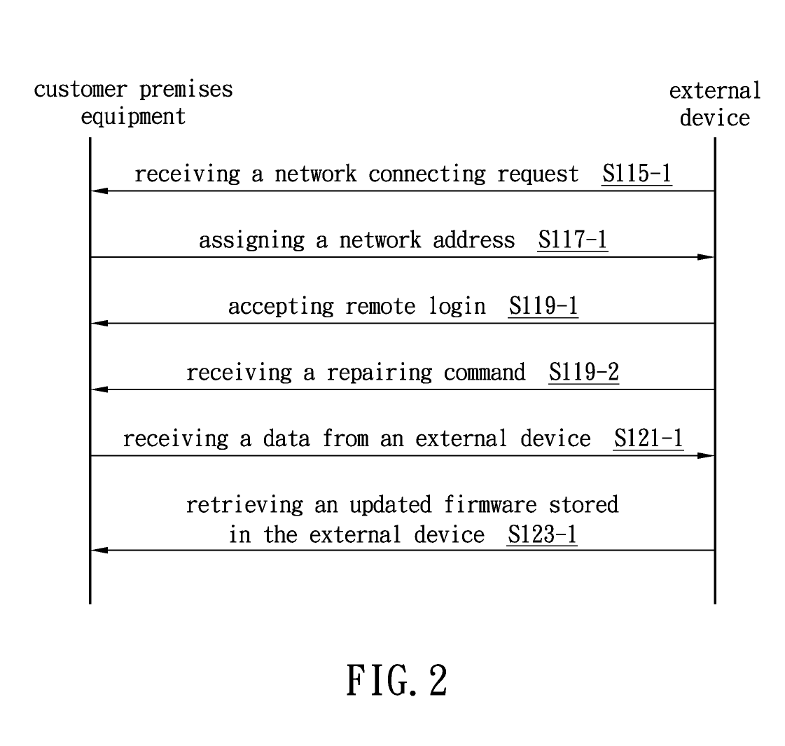

In the above-mentioned description, the updated firmware stored in the external device and retrieved by the CPE serves as the new first firmware. After the physical connection between the CPE and the external device is established via network cable, the CPE and the external device may transmit data and commands via various network services activated in the CPE. Please refer to FIG. 2 indicative of a procedure of communication between the CPE and the external device according to an exemplary embodiment of the present disclosure.

When the physical connecting between the external device and the CPE is established, the external device may broadcast the network connecting request to all other network devices in the same sub-network to search for a device which may assign the network address (S115-1). If the DHCP service is activated on the CPE, the CPE may respond to the external device and assign a suitable network address to the external device (S117-1), and waiting for confirmation of an acceptance of the arrangement of the DHCP server by the external device. The above-mentioned processes may correspond to steps S115 to S117 in FIG. 1.

After accomplishing the network connection with the CPE, the external device with the assigned network address may log onto the CPE according to the network address of the CPE (S119-1). For example, the external device may log onto the CPE by following the Telnet protocol so as to send commands to the CPE (S119-2) and control the CPE to execute the repairing process. The above-mentioned process may correspond to step S119 in FIG. 1.

According to the repairing program, the CPE receives a data from the external device based on the network address assigned to the external device (S121-1). In the present embodiment, the CPE may log onto the external device providing the file transfer service via a predetermined ID and password, for retrieving the updated firmware stored in the external device in order to replace the damaged first firmware (S123-1). The above-mentioned processes may correspond to steps S121 to S123 in FIG. 1.

It is noteworthy that the above-mentioned locations for the firmware and ways of indicating the damaged firmware and switching firmware are only for the purpose of illustration, and, one of ordinary skill in the art will realize that the invention might be practiced without the use of these specific details.

[Exemplary Embodiment of the Firmware Repairable CPE]

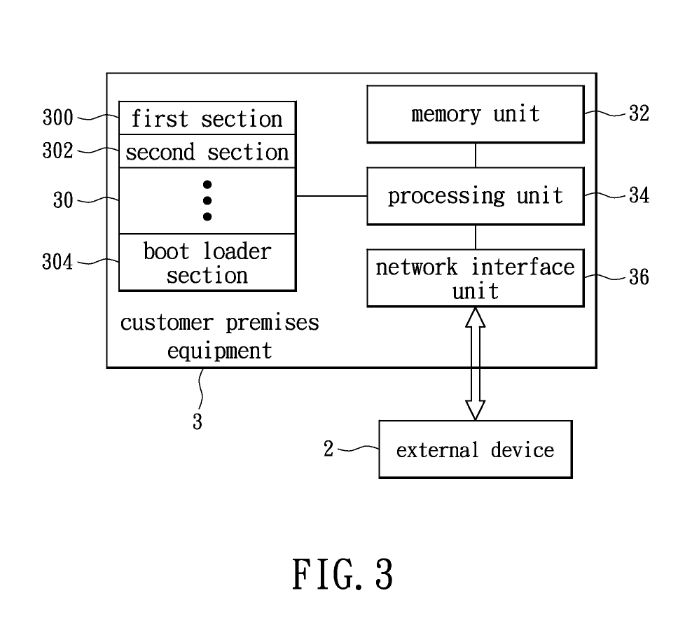

Please refer to FIG. 3 which is a block diagram of a CPE capable of repairing firmware therein according to an exemplary embodiment of the present disclosure. The CPE may be capable of performing the repairing method of the above-mentioned exemplary embodiment. The CPE 3 includes a storage unit 30, a memory unit 32, a processing unit 34, and a network interface unit 36. The storage unit 30 includes a plurality of storage sections, such as a first section 300, a second section 302, and a boot loader section 304. The storage unit 30, the memory unit 32, and the network interface unit 36 are connected with and controlled by the processing unit 34. The network interface unit 36 may further connect to an external device 2 via a network cable.

The storage unit 30 may be a non-volatile memory, such as a flash memory, an EPROM (Erasable Programmable Read Only Memory), or the like, for storing data related to operations of the CPE 3. In the storage unit 30, the first section 300, the second section 302, and the boot loader section 304 may be adjacent to each other or separated from each other. The first section 300 may be used for storing the first firmware of the CPE 3, the second section 302 may be used for storing the second firmware, and the boot loader section 304 may be used for storing the boot loader program of the CPE 3. The arrangement of the above-mentioned storage sections is merely an example. The storage unit 30 may include a plurality of non-volatile memory chips, with the first firmware, the second firmware, and the boot loader program stored in each of the memory chips respectively. The above-mentioned firmware or program in the storage unit 30 may be saved in terms of image files, and every image file may have a corresponding file name. The storage unit 30 may further store a verification program for determining whether the first firmware is damaged, and a switch program for switching to the second firmware when the first firmware is determined damaged. The verification program and the switch program may be included in the boot loader program.

The memory unit 32 may be a volatile memory such as a random access memory (RAM), for the first firmware, the second firmware or the boot loader program to be loaded into. The firmware boot loader program may be decompressed to be an executable program for being executed by the processing unit 34 when the firmware boot loader program is loaded into the memory unit 32.

When the CPE 3 boots, the processing unit 34 may load the boot loader program inside the boot loader section 304 into the memory unit 32 at first before determining the integrity of the predetermined first firmware according to boot loader program, switch to the second firmware when the first firmware is determined damaged, and load one of the first firmware and second firmware into the memory unit 32 depending on whether the first firmware has been determined damaged. After the first firmware or the second firmware is loaded into the memory unit 32, the processing unit 34 may set the CPE 3 according to the decompressed first firmware or the second firmware in the memory unit 32, before an operating system launches. The processing unit 34 may be a central processing unit (CPU), a microcontroller or an embedded controller and so on.

The network interface unit 36 may be an Ethernet port utilized for connecting the external device 2 and the CPE 3 via the network. The external device 2 may therefore remotely control the CPE 3, which may also be able to access the data stored in the external device 2.

The external device 2 stores the updated firmware. The external device 2 may be a notebook or a mobile computing apparatus capable of connecting to the CPE 3 via the network interface unit 36 when the firmware of the CPE 3 is damaged. The external device 2 may be capable of providing file sharing service as well, by executing the file transfer protocol (FTP) in order to serve as a FTP server.

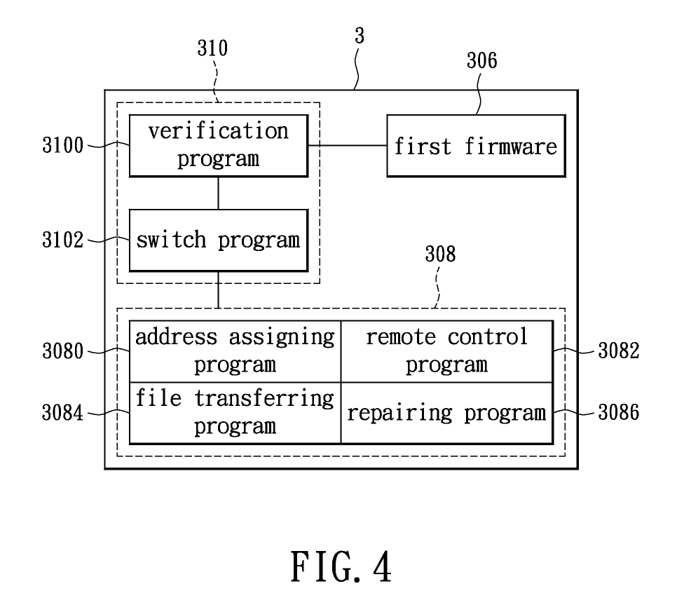

Please refer to FIG. 4 which shows a block diagram of a CPE that is capable of repairing firmware therein according to an exemplary embodiment of the present disclosure. In FIG. 4, the CPE 3 includes an image file of the first firmware 306 and a corresponding operating system, a verification code, a firmware version number, and a verification value. In addition to the operating system, the second firmware 308 may further include an address assigning program 3080, a remote control program 3082, a file transferring program 3084, and a repairing program 3086. The boot loader program 310, meanwhile, may include a verification program 3100 for determining the integrity of the first firmware 306, and a switch program 3102 for enabling a switch from the first firmware 306 to the second firmware 308 when the first firmware 306 is determined damaged. The aforementioned programs may be stored in the storage unit 30 shown in FIG. 3, and loaded and decompressed respectively into the memory unit 32 in FIG. 3 before being executed by the processing unit 34.

The first firmware 306 may be set to be a predetermined or a main firmware. Therefore, after the booting of the CPE 3, the processing unit 304 may go to a starting address of the first firmware 306 according to the execution of the boot loader program 310, or read the first firmware 306 according to the file name of the first firmware 306. The processing unit 304 may execute the verification program 3100 for determining whether the first firmware 306 is damaged.

When the first firmware 306 is determined damaged, the verification program 3100 may be used to indicate the first firmware 306 is damage, such as asserting a switch flag in a specific address of the memory unit 32. Next, the switch program 3102 may read the asserted switch flag at the specific address, and switch to the second firmware 308 which will be loaded to the memory unit 32 according to the assertion of the switch flag. Specifically, the switch program 3102 may be executed to rename the first firmware 306 when the asserted switch flag is read, and rename the first firmware 306 after another file name of another firmware and the file name of the second firmware 308 after the original file name of the first firmware 306. Therefore the switch program 3102 may then directly read the second firmware 308 that has the same file name as that of the first firmware 306 and the image file of the second firmware 308 from the starting address of the second firmware 308 for the executing purpose, instead of the damaged first firmware 306.

It is noteworthy that asserting the switch flag is an example for indicating the damaged firmware in the present embodiment. In other exemplary embodiments, the verification program 3100 been used to compare the verification value with the comparison value and to generate a true/false value, and the switch program 3102 may switch to the second firmware 308 according to the true or false value. Moreover, it is not limited to switch the firmware by renaming the file name of the firmware. In other exemplary embodiments, a pre-recorded starting address of the second firmware 308 may be recorded in advance and in the event that the first firmware 306 has been determined damaged the processing unit 304 may go to the pre-recorded starting address of the second firmware 308 to access the image file of the second firmware 308.

Please refer to FIG. 4 again. When the second firmware 308 is decompressed and loaded to the memory unit 32, the image files of the address assigning program 3080, the remote control program 3082, the file transferring program 3084, and the repairing program 3086 are decompressed at the same time so as to become executable codes for the repairing purposed of the damaged first firmware 302.

It is noted that the terms of the CPE and the “client” shown in the following description may be interchangeable. From the perspective of network or telecommunication service providers, the CPE may be referred to as a terminal to be installed at subscriber's premises for subscribing network or telecommunication services. The client in the instant exemplary embodiment may be a party requesting for resources or services in the server.

Please refer to FIG. 4, the address assigning program 3080 may be a dynamic host configuration protocol (DHCP) server-end program, and the processing unit 34 may execute codes of the program for causing the CPE 3 to serve as the DHCP server in the DHCP setting and be capable of automatically assigning network addresses to other client devices in the same sub-network. In other words, the processing unit 34 may execute the address assigning program 3080 for assigning a network address to the external device 2 (as shown in FIG. 3) connecting to the CPE 3 via the network interface unit 36 and the network cable.

The remote control program 3082 may be a Telnet protocol server-end program allowing for the CPE 3 serve as a remote server and the external device 2 may log onto the CPE 3 via the network. Therefore, the external device 2 may remotely control the operations of the CPE 3.

The file transferring program 3084 may be a FTP client program, and the processing unit 34 may execute the codes of the file transferring program 3084 to connect to the external device 2 for accessing the data stored in the external device 2. It is noteworthy that the external device 2 may include the FTP server program corresponding to the file transferring program 3084. The external device 2 may execute the codes of the FTP server program so that the external device 2 may serve as an FTP server. Therefore, the processing unit 34 of the CPE 3 may execute the file transferring program 3084 and log onto the FTP server based on the network address of the external device 2 which may be assigned by the address assigning program 3080, and retrieve the files (e.g., the updated firmware) from the external device 2.

The repairing program 3086 may be a script used for repairing the first firmware 306. The CPE 3 may sequentially connect to and access the data stored in the external device 2 for repairing the damaged first firmware 306 according to the above-mentioned network services and the instructions provided by the executed script of the repairing program 3086.

Please refer to FIG. 3 and FIG. 4. After the execution of the second firmware 308 which has been renamed and loaded in the memory unit 32, the external device 2 connected with the CPE 3 via the network interface unit 36 may search for the DHCP server in the same sub-network before eventually locating the CPE 3. The CPE 3 serving as the DHCP server may assign the network address to the external device 2. Therefore, the network connection between the external device 2 and CPE 3 may be established. The external device 2 may thereafter log onto the CPE 3 to execute the repairing program 3086 to repair the first firmware 306. For example, the external device 2 serving as the client may log onto the Telnet server according to the network address of the CPE 3. Next, the external device 2 as the client may generate a repairing command to control the CPE 3 to execute an edited script stored in the second firmware 308.

The script may be used to drive the CPE 3 to execute the FTP client program, log onto the FTP server (i.e. the external device 2) and download the updated firmware stored in the FTP server. The updated firmware may be a complete and undamaged firmware image compatible in the CPE 3. When downloading the updated firmware, in addition to duplicating the updated firmware to the CPE 3, the processing unit 34 may further rename the duplicated updated firmware after the original file name of the first firmware 306, and store the renamed updated firmware in the first section 300 of the storage unit 30 for replacing the damaged firmware of the first section 300. The script may further include de-asserting the switch flag after the updated firmware has been stored to the first section 300.

Therefore, after the re-booting of the CPE 3, the processing unit 34 may read the updated firmware at the first section 300 according to the boot loader program 3100, and to compare the verification value of the updated first firmware 306 with the comparison value by the verification program 3100. Once the verification value is substantially identical to the comparison value, the processing unit 34 will load the updated first firmware 306 into the memory unit 32, and the CPE 3 may successfully complete the booting process before the operating system could eventually take over.

To sum up, according to the exemplary embodiment of the present disclosure, the above-mentioned CPE and the firmware repairing method thereof may automatically determine the integrity of the main firmware of the CPE (such as the first firmware of the exemplary embodiment), and automatically switch to a spare firmware (such as the second firmware of the exemplary embodiment) when the main firmware is damaged, in order to ensure the CPE to properly function without being affected by the damage to the main firmware.

Furthermore, the exemplary embodiments of the present disclosure allow the CPE to communicate with the external device via the network connection, removing the limitation of the traditional CPE such as the range of the physical cable, and facilitating the access to the CPE that is often installed at positions beyond people's reach. Furthermore, since most of the CPEs are equipped with network connection capability, implementation of the firmware repairing of the CPE disclosed in the present disclosure may not need additional hardware.

Moreover, since the CPE disclosed in the present disclosure is associated with the network connection and the address assigning service, the external device is capable of automatically obtaining the required network address for the purpose of the network connection with the CPE. Therefore, the CPE disclosed in the present disclosure may operate without being manually configured, reducing the complexity of the repairing program.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims

What is claimed is:

1. A firmware repairing method of a customer premises equipment (CPE), wherein the CPE includes a storage unit, a processing unit, and a network interface unit, comprising:
reading a first firmware stored in the storage unit and determining whether the first firmware is damaged;
reading a second firmware stored in the storage unit when the first firmware is determined damaged, and loading the second firmware into a memory unit for an execution of the second firmware;
activating network services based on instructions of the second firmware and enabling a communication between the CPE and an external device via the network services;
receiving control-related commands from the external device for executing a repairing program; and
receiving an updated firmware from the external device for replacing the damaged first firmware according to the repairing program.

2. The firmware repairing method according to claim 1, wherein determining whether the first firmware is damaged further comprises:
reading a verification value pre-stored in the first firmware; and
calculating a comparison value of data of the first firmware, and comparing the comparison value with the verification value, and determining the first firmware is damaged when the verification value and the comparison value are inconsistent.

3. The firmware repairing method according to claim 1, before loading the second firmware into the memory unit further comprising:
asserting a switch flag for indicating the first firmware has been damaged.

4. The firmware repairing method according to claim 3, wherein reading and loading the second firmware into the memory unit further comprises:
reading the second firmware based on the asserted switch flag;
renaming the second firmware after a file name of the first firmware; and
loading the renamed second firmware to the memory unit for the execution of the second firmware.

5. The firmware repairing method according to claim 4, after receiving the updated firmware for replacing the damaged first firmware with the renamed second firmware further comprising:
de-asserting the switch flag.

6. The firmware repairing method according to claim 1, before enabling the communication between the CPE and the external device further comprising:
executing an address assigning program for activating a network address assigning service.

7. The firmware repairing method according to claim 6, wherein enabling the communication between the CPE and the external device further comprises:
receiving a network connecting request for the communication between external device and the CPE; and
assigning a network address to the external device based on the network connecting request and the network address assigning service, so as to allow for the external device to be in connection with the CPE via the network address.

8. The firmware repairing method according to claim 7, before receiving the control-related commands from the external device for executing the repairing program further comprising:
executing a remote control program for activating a remote login service.

9. The firmware repairing method according to claim 8, wherein receiving the control-related commands from the external device for executing the repairing program further comprises:
allowing for the external device to login the CPE according to the remote login service via the network; and
receiving a repairing command sent from the external device to execute the repairing program.

10. The firmware repairing method according to claim 9, before receiving the updated firmware further comprising:
performing a file transferring program for activating a file transferring service.

11. The firmware repairing method according to claim 10, wherein receiving the updated firmware further comprises:
accessing the updated firmware according to the file transferring program;
duplicating the updated firmware and renaming the updated firmware after the file name of the damaged first firmware;
saving the duplicated and renamed updated firmware to the storage unit; and
rebooting the CPE.

12. The firmware repairing method according to claim 10, wherein the address assigning program is a dynamic host configuration protocol program, the remote control program is a telnet protocol program, and the file transferring program is a file transfer protocol program.

13. A firmware repairable customer premises equipment (CPE), comprising:
a storage unit, for storing a first firmware and a second firmware;
a network interface unit, for connecting to an external device; and
a processing unit, for determining whether the first firmware is damaged when booting the CPE, and loading the second firmware into a memory unit for executing the second firmware when the first firmware is determined damaged;
wherein the processing unit is configured to execute the first firmware for activating network services, enabling the communication between the external device and the CPE, and receiving an updated firmware from the external device to repair the damaged first firmware.

14. The firmware repairable CPE according to claim 13, wherein the first firmware includes a verification value and the processing unit calculates a comparison value based on data of the first firmware and compares the verification value with the comparison value before determining the first firmware is damaged.

15. The firmware repairable CPE according to claim 13, wherein the processing unit renames the second firmware after a file name of the damaged first firmware when the first firmware is determined damaged, and loads the renamed second firmware into the memory unit.

16. The firmware repairable CPE according to claim 13 further comprising:
a verification program, for verifying the first firmware and determining whether the first firmware is damaged; and
a switch program, for selecting the second firmware when the first firmware is determined damaged.

17. The firmware repairable CPE according to claim 13, wherein the second firmware further comprises:
an address assigning program, for assigning a network address to the external device;
a remote control program, for allowing for the external device to control the CPE; and
a file transfer program, for receiving the updated firmware from the external device.

18. The firmware repairable CPE according to claim 17, wherein the processing unit executes the second firmware to allow for the external device to connect to the CPE via the network address, and enable the external device to control the CPE to execute a repairing program for repairing the first firmware.

19. The firmware repairable CPE according to claim 18, wherein the processing unit receives the updated firmware sent from the external device and renames the updated firmware after the file name of the damaged first firmware for replacing the damaged first firmware according to the repairing program.

20. A computer readable storage medium having recorded therein a set of computer programs including a first firmware, a second firmware, a verification program, and a switch program, for carrying out a firmware repairing method comprising steps according to claim 1.
